(19) United States
(12) Patent Application Publication
(10) Pub. No.: US 2022/0242492 A1
(43) Pub. Date: Aug. 4, 2022

(54) SYSTEM OF A REINFORCED BODY ELEMENT

(71) Applicant: SIKA TECHNOLOGY AG, Baar (CH)

(72) Inventors: Dusko PARIPOVIC, Zürich (CH); Michele GATTI, Frick (CH); Stephan NIGGEMANN, Widen (CH); Sabine WENIG, Fahrwangen (CH); Reto DOHNER, Zürich (CH)

(73) Assignee: SIKA TECHNOLOGY AG, Baar (CH)

(21) Appl. No.: 17/615,614

(22) PCT Filed: Jul. 17, 2020
(86) PCT No.: PCT/EP2020/070368

§ 371 Date: Dec. 1, 2021

(30) Foreign Application Priority Data
Jul. 19, 2019 (EP) 19187380.1

(51) Int. Cl. B62D 29/00; B62D 29/04; B32B 15/08; B32B 7/12

(52) U.S. Cl. CPC B62D 29/002; B62D 29/043; B62D 25/06; B32B 7/12; B32B 15/08

(57) ABSTRACT

A system of a reinforced body element of a motor vehicle which includes a body element, an expansion material and a reinforcing layer. The expansion material has an expansion rate of at least 200%. Furthermore, the expansion material is arranged between the body element and the reinforcing layer.

The invention relates to a system of a reinforced body element of a motor vehicle. It furthermore relates to a method for reinforcing a body element in a motor vehicle.

In automotive construction, efforts are continuously being made to save weight. For this reason, for example body elements, such as metal sheets, are embodied with very thin material thicknesses. Very thin metal sheets are therefore used in particular in regions which are not of crucial importance for the overall stability of the vehicle, such as for example a roof element. In order to nevertheless obtain sufficiently good mechanical properties of such elements, and also satisfy other requirements, such as for example the reduction of noises and vibrations, such body elements are reinforced by sandwich panels. Such sandwich panels are typically adhesively bonded to the body elements. The sandwich panels for their part are composed, for example, of honeycomb structures, which are clamped between two reinforcing layers.

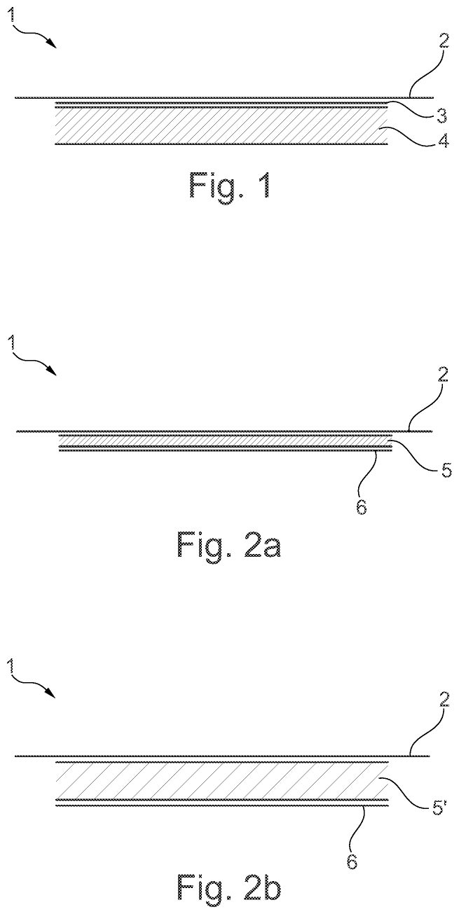

Such a known system of a reinforced body element 2 in a motor vehicle is illustrated in FIG. 1. In this case, the system 1 comprises a body element 2, an adhesive 3 and a sandwich panel 4. The sandwich panel 4 is adhesively bonded to the body element 2 by the adhesive 3.

However, this known solution for reinforcing thin body elements has the disadvantage that such sandwich panels have to be newly manufactured for each new body shape because this type of panels have to be prefabricated and adapted to the three-dimensional shapes of the body. There is often also the risk that visible traces arise on an outer side of the sheets as a result of the adhesive bonding of the panels. Furthermore, such panels often have a certain thickness, such that valuable space in the interior of the passenger compartment is lost.

It is therefore an object of the present invention to provide an improved system of a reinforced body element in motor vehicles that avoids the disadvantages of the prior art.

This object is achieved by a system of a reinforced body element of a motor vehicle, the system comprising: a body element; an expansion material having an expansion rate of at least 200%; and a reinforcing layer; wherein the expansion material is arranged between the body element and the reinforcing layer.

A core concept of the present invention is that the system proposed here does not require prefabricated and custom-made elements but that the individual elements of the system (the expansion material and the reinforcing element) can be produced as material sold by the meter and can be adapted to any type of body elements. This has the effect of simplifying, and reducing the cost of, a production operation of such systems to a significant extent. In particular, a new reinforcing system does not need to be prefabricated for each body shape, rather standardized elements can be used for a wide variety of body element shapes.

A further advantage of the solution proposed here can be seen in that visible deformations on the body element can be avoided as a result of the different type of connection to the body element.

Furthermore, the solution proposed here has the advantage that a significant weight saving can be achieved as a result.

In addition, the solution proposed here affords the advantage that the expansion material can be configured so as to bear against the body element in a continuous manner, as a result of which both thermal and acoustic properties of the system can be improved.

In connection with the present invention, the expression “expansion rate of at least X %” means that a volume of an element increases by the factor of the expansion rate. By way of example, an expansion rate of 200% therefore means that an element gains two times its original volume during an expansion operation. A volume after such an expansion of the element is thus three times as great as the original volume. An expansion of 0% correspondingly means that the volume of the element does not change. An expansion rate of 100% correspondingly means that a volume of an element doubles as a result of an expansion operation.

In an exemplary embodiment, the expansion rate of the expansion material is at least 500%, preferably at least 800%, preferably at least 1200%, particularly preferably at least 1500%.

In principle, higher expansion rates of the expansion material make it possible to achieve a weight reduction of the overall system.

In an exemplary embodiment, the expansion material in an unexpanded state has a layer thickness of between 0.1 mm and 3 mm, preferably of between 0.3 mm and 2 mm, particularly preferably of between 0.5 mm and 1.5 mm.

In an exemplary embodiment, the expansion material in an expanded state has a layer thickness of between 3 and 12 mm, preferably of between 4 and 10 mm, particularly preferably of between 5 and 8 mm.

In an exemplary embodiment, the expansion material can be expanded by a temperature of at least 120° C.

This has the advantage that, as a result, the expansion material proposed here can be activated in a finishing oven, as is used in the production process of automobiles. Separate activation of the expansion material is thus not necessary.

In an exemplary embodiment, the reinforcing layer has a layer thickness of between 0.05 mm and 0.2 mm, preferably of between 0.08 and 0.12 mm.

In an exemplary embodiment, the reinforcing layer contains one or more of the following materials: paper, aluminum, fibers, natural fibers, synthetic fibers, carbon fibers, glass fibers, plastic, in particular polyamide or polyethylene or polypropylene.

In an exemplary embodiment, an area of the expansion material is greater than 0.1 m², preferably greater than 0.3 m², preferably greater than 0.5 m², particularly preferably greater than 0.8 m².

In an exemplary embodiment, an area of the reinforcing layer is greater than 0.1 m², preferably greater than 0.3 m², particularly preferably greater than 0.5 m², particularly preferably greater than 0.8 m².

In an exemplary embodiment, the reinforcing layer completely covers the expansion material.

In an alternative embodiment, the reinforcing layer partially covers the expansion material, such that a partial region of the expansion material is not covered with the reinforcing layer.

In a further alternative embodiment, the reinforcing layer completely covers the expansion material, wherein an area of the reinforcing layer is greater than an area of the expansion material, such that there are partial regions of the reinforcing layer which are not arranged above the expansion material.

In an exemplary embodiment, the expansion material and/or the reinforcing layer form/forms a continuous surface. In an exemplary refinement, the continuous surface has substantially a rectangular or a trapezoidal or a polygonal shape. In particular, the corners may be rounded in this case.

In an alternative embodiment, the expansion material and/or the reinforcing layer do/does not form a continuous surface. In an exemplary refinement, the surface has one or more cutouts. In particular, these cutouts have a round or an oval or a rectangular or a trapezoidal or a polygonal or an irregular shape.

In an exemplary refinement, the surface of the expansion material and/or of the reinforcing layer has a plurality of cutouts. In particular, these cutouts are arranged in a regular pattern, such as for example in rows, in columns, or in a checkerboard-like manner.

In an exemplary embodiment, the body element is formed from steel or aluminum or carbon or several of the mentioned materials.

In an exemplary embodiment, the body element is a roof element of a motor vehicle.

In an exemplary embodiment, the expansion material is a thermoplastic material.

In an exemplary embodiment, the expansion material comprises matrix polymers. In an exemplary refinement, these matrix polymers are composed of ethylene-vinyl acetate or ethylene-alkyl acrylate.

In an exemplary embodiment, the expansion material is produced by an extrusion process, by calendering, by injection molding or by a 3D printing process.

In an exemplary refinement, the expansion material can be processed between 50° C. and 160° C., preferably between 80° C. and 140° C., by these processes.

In an exemplary embodiment, the expansion material is connected to the body element by thermal bonding, or by a pressure-sensitive adhesive, or by a hotmelt adhesive or by magnetic attraction.

In a further exemplary embodiment, the expansion material is pumpable between room temperature and 60° C. In this case, in particular the expansion material is first of all applied to the body element and then covered with the reinforcing layer. As an alternative to this, the expansion material can first of all be applied to the reinforcing layer, and then the reinforcing layer together with the expansion material can be adhesively bonded to the body element, with the result that the expansion material is arranged between the body element and the reinforcing layer.

Such expansion materials are obtainable, for example, under the trade names SikaBaffle-250NT, SikaBaffle-450, SikaBaffle-455, SikaSeal-761 or SikaSeal-830.

The object stated at the outset is furthermore achieved by a method for reinforcing a body element in a motor vehicle, wherein the method comprises the following steps: providing a body element; providing an expansion material with a reinforcing layer; arranging the expansion material with the reinforcing layer on the body element so that the expansion material is between the body element and the reinforcing layer; wherein the expansion material has an expansion rate of at least 200%.

In an exemplary embodiment, the expansion material is expanded after it is arranged on the body element.

In an alternative embodiment, the expansion material is expanded before it is arranged on the body element.

In an exemplary embodiment, the method is carried out using a system according to the description above.

Details and advantages of the invention will be described below on the basis of exemplary embodiments and with reference to schematic drawings. In the drawings:

FIG. 1 shows an exemplary illustration of a system of a reinforced body element according to the prior art;

FIG. 2a shows a schematic illustration of an exemplary system of a reinforced body element, wherein an expansion material is illustrated in an unexpanded state; and

FIG. 2b shows a schematic illustration of an exemplary system of a reinforced body element, wherein an expansion material is illustrated in an expanded state.

FIGS. 2a and 2b each show a system 1 of a reinforced body element 2. Here, an expansion material 5 is illustrated in an unexpanded state in FIG. 2a, wherein the expansion material 5′ is illustrated in an expanded state in FIG. 2b. The system 1 furthermore comprises a reinforcing element 6. Here, the expansion material 5, 5′ is arranged between the body element 2 and the reinforcing element 6.
LIST OF REFERENCE DESIGNATIONS
1 System
2 Body element
3 Adhesive
4 Sandwich panel
5 Expansion material in an unexpanded state
5′ Expansion material in an expanded state
6 Reinforcing element

1. A system of a reinforced body element of a motor vehicle, the system comprising:
a body element;
an expansion material having an expansion rate of at least 200%; and
a reinforcing layer;
wherein the expansion material is arranged between the body element and the reinforcing layer.

2. The system as claimed in claim 1, wherein the expansion material in an unexpanded state has a layer thickness of between 0.1 mm and 3 mm.

3. The system as claimed in claim 1, wherein the expansion material in an expanded state has a layer thickness of between 3 mm and 12 mm.

4. The system as claimed in claim 1, wherein the expansion material can be expanded by a temperature of at least 120° C.

5. The system as claimed in claim 1, wherein the reinforcing layer has a layer thickness of between 0.05 mm and 0.2 mm.

6. The system as claimed in claim 1, wherein the reinforcing layer contains one or more of the following materials: paper, aluminum, fibers, natural fibers, synthetic fibers, carbon fibers, glass fibers, plastic or epoxy resin.

7. The system as claimed in claim 1, wherein an area of the expansion material is greater than 0.1 m².

8. The system as claimed in claim 1, wherein an area of the reinforcing layer is greater than 0.1 m².

9. The system as claimed in claim 1, wherein the reinforcing layer completely covers the expansion material.

10. The system as claimed in claim 1, wherein the body element is formed from steel and/or aluminum and/or carbon.

11. The system as claimed in claim 1, wherein the body element is a roof element.

12. A method for reinforcing a body element in a motor vehicle, the method comprising the following steps:
providing a body element;
providing an expansion material with a reinforcing layer;
arranging the expansion material with the reinforcing layer on the body element so that the expansion material is between the body element and the reinforcing layer;
wherein the expansion material has an expansion rate of at least 200%.

13. The method as claimed in claim 12, wherein the expansion material is expanded after it is arranged on the body element.

14. The method as claimed in claim 12, wherein the expansion material is expanded before it is arranged on the body element.

15. The method as claimed in claim 12, wherein the method is carried out using a system of a reinforced body element of a motor vehicle, the system comprising:
a body element;
an expansion material having an expansion rate of at least 200%; and
a reinforcing layer;
wherein the expansion material is arranged between the body element and the reinforcing layer.
